(19) United States
(12) Patent Application Publication
(10) Pub. No.: US 2020/0166403 A1
(43) Pub. Date: May 28, 2020

(54) AMBIENT LIGHT SENSOR

(71) Applicant: Chip Goal Electronics Corporation, Hsinchu (TW)

(72) Inventors: Chien-Teng Huang, Hsinchu (TW); Jeng-Feng Lan, Hsinchu (TW)

(21) Appl. No.: 16/264,829

(22) Filed: Feb. 1, 2019

(30) Foreign Application Priority Data
Nov. 28, 2018 (TW) 107216126

(51) Int. Cl. G01J 1/16; G01J 1/42; G01J 1/44

(52) U.S. Cl. CPC G01J 1/1626; G01J 1/44; G01J 1/4204

(57) ABSTRACT

An ambient light sensor for sensing illuminance of ambient light includes: a photo sensor unit, for sensing ambient light to generate a sensing signal; a reference sensor unit coupled to the photo sensor unit, for generating a reference signal in response to a condition of not sensing the ambient light; and a control circuit, which is coupled to the photo sensor unit and the reference sensor unit for generating an ambient light illuminance signal according to the sensing signal and the reference signal. Each of the photo sensor unit and the reference sensor unit includes at least one illuminance sensor device, wherein the at least one illuminance sensor device of the photo sensor unit and the at least one illuminance sensor device of the reference sensor unit are arranged in common centroid in a circuit layout.

### CROSS REFERENCE

The present invention claims priority to TW 107216126, filed on Nov. 28, 2018.

### BACKGROUND OF THE INVENTION

### Field of Invention

The present invention relates to an ambient light sensor; particularly, it relates to such an ambient light sensor which is capable of reducing leakage current and temperature effect.

### Description of Related Art

An ambient light sensor is for sensing illuminance of ambient light to generate an ambient light illuminance signal. The ambient light signal can be applied to mobile electronic devices such as mobile phones, tablet computers, and notebook computers. It can also be used in apparatuses in daily life such as monitors, street lights, car display and lighting, and LCD TVs, etc. For an application example, when the ambient light is dark (low illumination), the eye pupils will be magnified; in this case if the brightness of the screen of an electronic device is too high, it will make the user feel uncomfortable. The ambient light signal generated by the ambient light sensor can be used to adjust the brightness of the screen of the electronic device to an illumination level acceptable by human eyes. For another example, when the ambient light is dark, the ambient light signal generated by the ambient light sensor can be used to automatically turn ON the street lights or headlights of the car, and when the ambient light is bright, the lighting device can be automatically turned OFF. In summary, the ambient light signal generated by the ambient light sensor can be used to adjust the screen brightness of an electronic device or to automatically turn ON/OFF lighting devices, to result in multiple benefits such as saving energy and extending the life of an electronic device, etc.

FIG. 1A shows a schematic diagram of a prior art ambient light sensor 10. The ambient light sensor 10 includes a photo sensor unit 110, a temperature sensor unit 120, and a control circuit 130. The photo sensor unit 110 senses the ambient light (as indicated by folded arrows shown in the figure) to generate a sensing signal, and the control circuit 130 receives the sensing signal and generates an ambient light illuminance signal which is positively correlated to the illuminance of the ambient light. The temperature sensor unit 120 includes a temperature-sensitive device which is used to sense a change of ambient temperature. The control circuit 130 corrects the sensing signal according to the change of the temperature sensed by the temperature sensor unit 120 so as to provide the ambient light illuminance signal.

The ambient temperature has a great influence on the sensing signal. The dark current effect caused by the ambient temperature on the sensing signal increases exponentially with the increase of the ambient temperature. It is necessary to compensate the dark current effect caused by the ambient temperature, otherwise the ambient light signal will be very inaccurate.

In the ambient light sensor 10, the temperature-sensitive device in the temperature sensor unit 120 for sensing the temperature change is, for example, a bandgap temperature sensor which includes a semiconductor device with temperature sensitivity, wherein the semiconductor device is for example a bipolar junction transistor (BJT). The bandgap temperature sensor senses the temperature change by two currents with different current densities which flow through two different PN junctions, and a voltage difference therebetween is proportional to an absolute temperature, so that the ambient light illuminance signal can be compensated according to temperature.

FIG. 1B shows a schematic diagram of a prior art temperature sensor unit 120. As shown in FIG. 1B, the temperature sensor unit 120 includes resistors R1, R2, R3, and R4, an error amplifier EA, and bipolar junction transistors T1 and T2. As shown in FIG. 1B, because the voltages of the two input terminals of the error amplifier EA are balanced at a same voltage level, the collector current IC1 flowing into the BJT T1 is proportional to the collector current IC2 flowing into the BJT T2 with a fixed ratio. The BJT T1 and the BJT T2 have different base-emitter junctions (and therefore have different current densities), and the absolute temperature can be calculated based on the collector current IC1 and the collector current IC2 according to the base-emitter voltage difference (AVBE) between the BJT T1 and the BJT T2. The relationship is as follows:

$$Δ {V}_{BE} = \frac{KT}{q} \times ln \frac{{I}_{C 1}}{{I}_{C 2}}$$

where K is the Boltzmann's constant, T is the absolute temperature, and q is the electron charge.

However, the temperature-sensitive device for sensing the temperature change in the temperature sensor unit 120 is different from the photo sensor device in the photo sensor unit 110 in their electronic characteristics in response to temperature changes, and therefore, the prior art ambient light sensor 10 cannot precisely compensate a temperature change to provide a very accurate ambient light illuminance signal.

In view of the above, to overcome the drawbacks in the prior art, the present invention proposes an ambient light sensor to reduce the temperature effect, which is able to precisely compensate the dark current, so as to increase the accuracy of the ambient light illuminance signal.

### SUMMARY OF THE INVENTION

In one perspective, the present invention provides an ambient light sensor, which is configured to operably sense illuminance of ambient light, the ambient light sensor comprising: a photo sensor unit, which is configured to operably sense ambient light to generate a sensing signal; a reference sensor unit, which is coupled to the photo sensor unit, and is configured to operably generate a reference signal in response to a condition of not receiving the ambient light; and a control circuit, which is coupled to the photo sensor unit and the reference sensor unit, and is configured to operably generate an ambient light illuminance signal according to the sensing signal and the reference signal; wherein each of the photo sensor unit and the reference sensor unit includes at least one illuminance sensor device; wherein the at least one illuminance sensor device of the photo sensor unit and the at least one illuminance sensor device of the reference sensor unit are arranged in common centroid in a circuit layout.

In one preferable embodiment, the illuminance of the ambient light is between 0.01 lux and 10 lux.

In one preferable embodiment, the illuminance sensor device is a semiconductor device with a PN junction.

In one preferable embodiment, the control circuit includes one single readout circuit, which is coupled to the photo sensor unit and the reference sensor unit, and the single readout circuit is configured to operably read out the sensing signal and the reference signal sequentially.

In one preferable embodiment, the control circuit performs dark current compensation of the sensing signal according to the reference signal, to generate the ambient light illuminance signal.

The objectives, technical details, features, and effects of the present invention will be better understood with regard to the detailed description of the embodiments below.

### BRIEF DESCRIPTION OF THE DRAWINGS

FIG. 1A shows a schematic diagram of a prior art ambient light sensor 10.

FIG. 1B shows a schematic diagram of a prior art temperature sensor unit 120.

FIG. 2 shows a first embodiment of the present invention.

FIG. 3 shows a second embodiment of the present invention.

FIG. 4 show a third embodiment of the present invention.

FIG. 5 shows a fourth embodiment of the present invention.

FIG. 6 shows a fifth embodiment of the present invention.

FIG. 7 shows a sixth embodiment of the present invention.

FIG. 8 shows a seventh embodiment of the present invention.

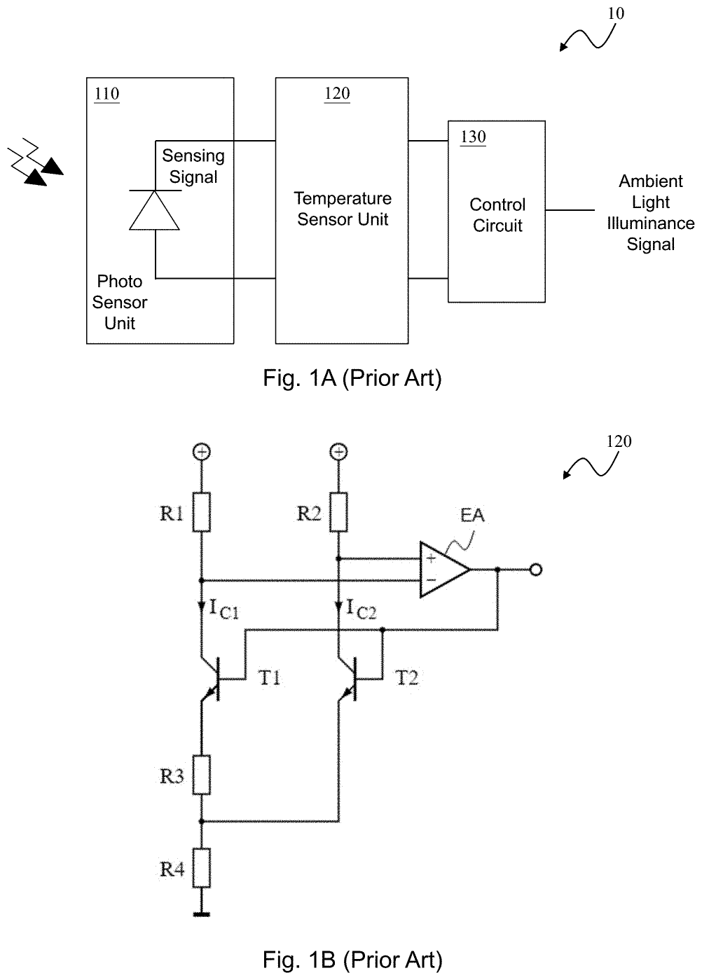

### DESCRIPTION OF THE PREFERRED EMBODIMENTS

The drawings as referred to throughout the description of the present invention are for illustration only, to show the interrelations between the circuits, and between the regions of the devices, but not drawn according to actual scale.

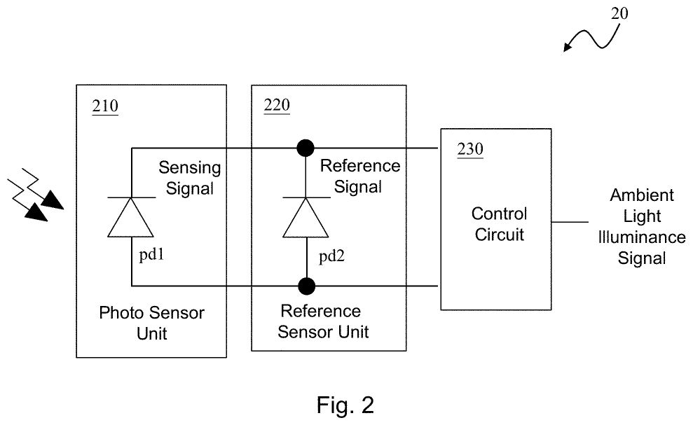

Please refer to FIG. 2 for a first embodiment according to the present invention. As shown in FIG. 2, the ambient light sensor 20 includes a photo sensor unit 210, a reference sensor unit 220, and a control circuit 230. The photo sensor unit 210 is configured to operably sense the ambient light (as indicated by folded arrows shown in the figure) to generate a sensing signal. The reference sensor unit 220, which is coupled to the photo sensor unit, is configured to operably generate a reference signal for reference; the reference sensor unit 220 does not receive the ambient light. The control circuit 230 is coupled to the photo sensor unit 210 and the reference sensor unit 220, and is configured to operably generate an ambient light illuminance signal according to the sensing signal and the reference signal.

The photo sensor unit 210 and the reference sensor unit 220 include illuminance sensor devices pd1 and pd2 respectively, wherein the illuminance sensor devices pd1 and pd2 are identical. In a preferable embodiment, the illuminance sensor devices pd1 and pd2 are the same in size and structure, and have an area for example but not limited to less than 100 micrometer square.

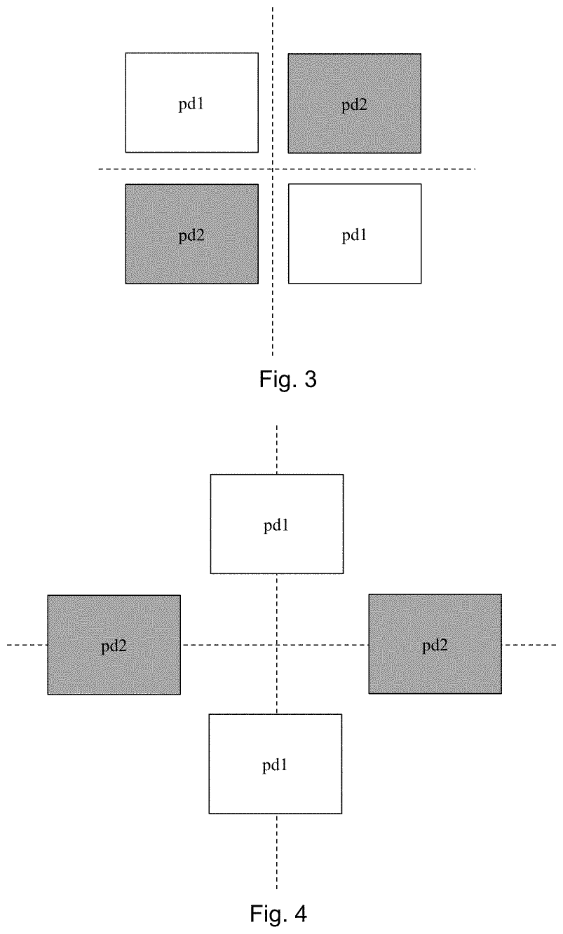

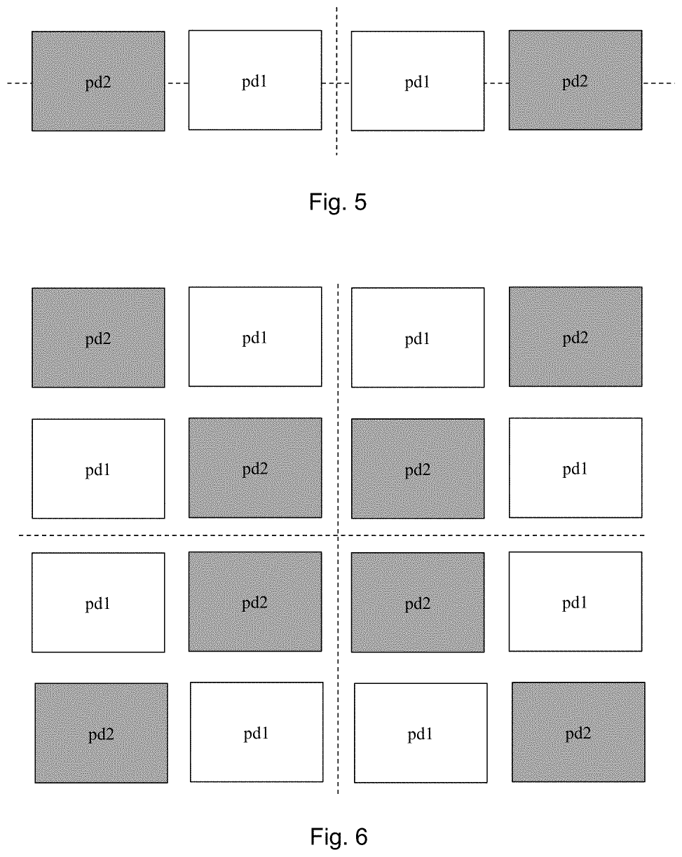

The illuminance sensor devices pd2 of the reference sensor unit 220 and the illuminance sensor devices pd1 of the photo sensor unit 210 are arranged in a common centroid circuit layout, that is, the layout (of an area including the illuminance sensor devices pd1 and pd2) is symmetric with respect to a geometry center of the area. There are various possible common centroid circuit layouts, and FIGS. 3, 4, 5, and 6 show several embodiments of common centroid circuit layouts wherein the illuminance sensor device pd2 of the reference sensor unit 220 and the illuminance sensor device pd1 of the light sensor unit 210 arranged in common centroid.

In short, although the prior art temperature-sensitive device of the temperature sensor unit 120 also uses the temperature characteristics of a PN junction to obtain a parameter related to the temperature, the prior art temperature-sensitive device is different from the photo sensor device in the photo sensor unit 110 in size, layout, and electronic characteristics such as voltage and current, and therefore their responses to temperature are different to cause inaccuracy in compensation. One technical feature of the present invention which is superior to the prior art is in that, in the present invention, the photo sensor unit and the reference sensor unit use the same illuminance sensor devices, and the illuminance sensor device of the photo sensor unit and the illuminance sensor device of the reference sensor unit are arranged in common centroid in a circuit layout. In this way, the temperature effect can be reduced more accurately, and the ambient light illuminance signal can be generated more precisely.

In one preferable embodiment, the illuminance of the ambient light is between 0.01 lux and 10 lux.

In one preferable embodiment, the illuminance sensor device pd1 is a semiconductor device with a PN junction, and the material forming the PN junction may be single-crystalline silicon, poly-crystalline silicon, amorphous silicon, or other semiconductor materials (for example, a III-V compound). The illuminance sensor device pd1 is for example but not limited to a phototransistor, a photodiode, or a photo IC integrated with an amplifier circuit.

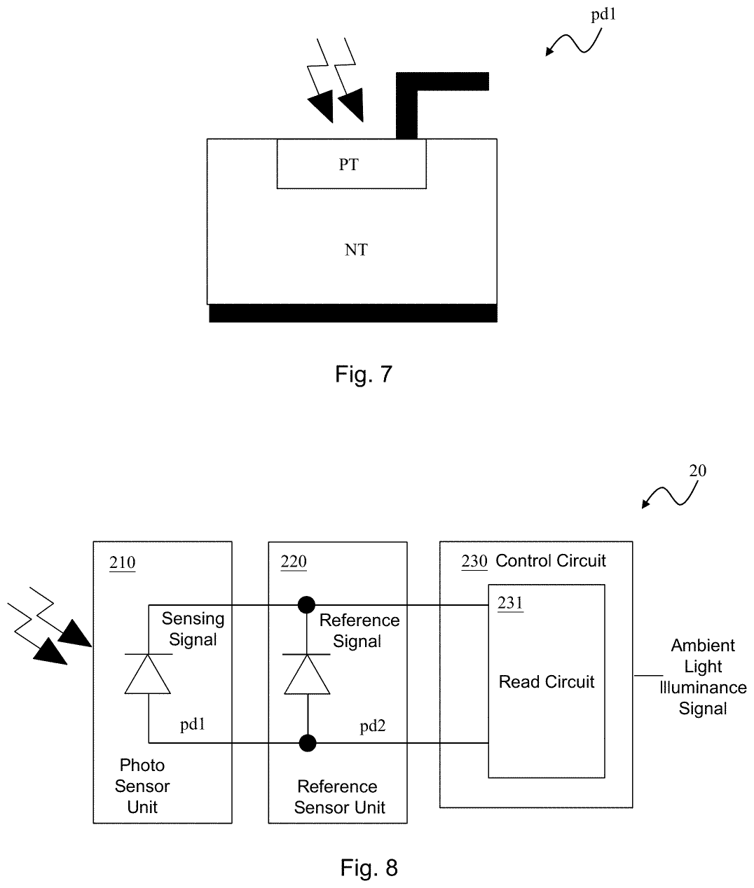

FIG. 7 shows a sixth embodiment of the present invention. As shown in FIG. 7, the illuminance sensor device pd1 has a P-type conductivity type region PT, an N-type conductivity type region NT, and electrical contacts thereof respectively (as indicated by thick black lines in the figure), wherein the P-type conductivity type region PT and the N-type conductivity type region NT form a PN junction. The illuminance sensor device pd2 is identical to the illuminance sensor device pd1 in size and structure, except the illuminance sensor device pd2 does not receiving ambient light. So that the dark current in the sensing signal generated by the illuminance sensor device pd1 can be accurately calculated according to the illuminance sensor device pd2, to improve the accuracy of the generated ambient light illuminance signal.

Please refer to FIG. 8 for a seventh embodiment according to the present invention. As shown in FIG. 8, in a preferable embodiment, the control circuit 230 includes a single readout circuit 231, which is coupled to the photo sensor unit 210 and the reference sensor unit 220, and the readout circuit 231 is configured to operably read out the sensing signal and the reference signal. The control circuit 230 performs dark current compensation on the sensing signal according to the reference signal to generate the ambient light illuminance signal. This embodiment shows that, in one preferable embodiment, the sensing signal and the reference signal are read out by one single readout circuit 231 in different time periods respectively (i.e., sequentially), so that the sensing signal and the reference signal are not impacted by different readout circuits such as by different amplifiers with different characteristics in the different readout circuits. However, it is certainly within the spirit of the present invention to employ two readout circuits to read out the sensing signal and the reference signal in parallel.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits in the shown embodiments, so the term “couple” should include direct and indirect connections. For another example, inverted and non-inverted input terminals of an error amplifier circuit or a comparator circuit are interchangeable, with corresponding amendments of the circuits processing these signals. For another example, when an external signal of a circuit is obtained and processed inside the circuit, the signal may be subject to a voltage-to-current conversion, a current-to-voltage conversion, or/and a ratio conversion, etc., and therefore, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. For another example, it is not limited for each of the embodiments described hereinbefore to be used alone; under the spirit of the present invention, two or more of the embodiments described hereinbefore can be used in combination. In view of the foregoing, the spirit of the present invention should cover all such and other modifications and variations, which should be interpreted to fall within the scope of the following claims and their equivalents.

What is claimed is:

1. An ambient light sensor, which is configured to operably sense illuminance of ambient light, the ambient light sensor comprising:
a photo sensor unit, which is configured to operably sense ambient light to generate a sensing signal;
a reference sensor unit, which is coupled to the photo sensor unit, and is configured to operably generate a reference signal in response to a condition of not receiving the ambient light; and
a control circuit, which is coupled to the photo sensor unit and the reference sensor unit, and is configured to operably generate an ambient light illuminance signal according to the sensing signal and the reference signal;
wherein each of the photo sensor unit and the reference sensor unit includes at least one illuminance sensor device;
wherein the at least one illuminance sensor device of the photo sensor unit and the at least one illuminance sensor device of the reference sensor unit are arranged in common centroid in a circuit layout.

2. The ambient light sensor of claim 1, wherein the illuminance of the ambient light is between 0.01 lux and 10 lux.

3. The ambient light sensor of claim 1, wherein the illuminance sensor device is a semiconductor device with a PN junction.

4. The ambient light sensor of claim 1, wherein the control circuit includes one single readout circuit, which is coupled to the photo sensor unit and the reference sensor unit, and the single readout circuit is configured to operably read out the sensing signal and the reference signal sequentially.

5. The ambient light sensor of claim 1, wherein the control circuit performs dark current compensation of the sensing signal according to the reference signal, to generate the ambient light illuminance signal.
